(19) United States
(12) Patent Application Publication
(10) Pub. No.: US 2011/0286619 A1
(43) Pub. Date: Nov. 24, 2011

(54) Ribbon transducer with improved distortion characteristics

(75) Inventor: George Elliott Short, III, Old Forge, NY (US)

(73) Assignee: George E. Short III, Old Forge, NY (US)

(21) Appl. No.: 12/800,578

(22) Filed: May 18, 2010

(51) Int. Cl. H04R 11/04

(52) U.S. Cl. 381/355

(57) ABSTRACT

A ribbon-type electroacoustic transducer with improved electrical, electromechanical, electromagnetic characteristics is described.

### BACKGROUND OF THE INVENTION

The invention was conceived of, designed and constructed as an electroacoustic transducer which displays improvement in distortion characteristics.

This type of electroacoustic transducer is usually referred to as a “ribbon” transducer and is generally used for audio reproduction applications as a high frequency, mid-frequency or full range unit.

Many conventional ribbon transducer designs employ a diaphragm assembly made of several rows of electrically conductive material (referred to as the “ribbon conductors”) adhered to an electrically non-conductive film, forming a diaphragm assembly generally referred to as a “ribbon diaphragm assembly”. The diaphragm may or may not be corrugated. This ribbon diaphragm assembly is suspended between two parallel rows of magnets adhered to a steel frame. The frame is generally composed of two parallel steel section connected to each other near their ends with cross members, and may have additional elements such as additional steel, wood, or other materials attached, all of this together forming the frame assembly. The static magnetic field created by the magnets is not isolated within the frame. Stray magnetic field is also present surrounding and penetrating the entire frame assembly.

The ribbon conductors are usually connected electrically in series, with the end of one conductor electrically connected to the start of another row via a conductive wire. These wires are referred to as the “return path wires”. This leaves the start of at least one ribbon conductor and the end of at least one return path wire unconnected, and these are used as the beginning and end of the electric circuit defined by the ribbon conductors and return path wires.

The electrical circuit composed of the ribbon conductors, return path wires and other associated wiring and circuitry is then connected to an electrical source such as an audio amplifier, which feeds current into the circuit. Interaction between alternating current flowing though the ribbon conductors and the static magnetic field causes the ribbon conductors and therefore the diaphragm to vibrate, producing sound.

Because the electrical current carried within the return path wires is immersed in magnetic field, the return path wires will also vibrate. Vibration of the return path wires within this magnetic field is undesirable because vibration induces an electromotive force on the electrons within the wires (called “back emf”) which then flow through the ribbon electrical circuit in the form of “back emf current”. The back emf current distorts the electrical signal from the amplifier, leading to acoustic distortion. In addition, the vibrating return path wires may create sound of their own or can buzz against each other and/or against the frame assembly. Past designs have partially solved this problem by bundling the return path wires or by adhering them at several points to the frame assembly.

Additionally, the alternating current flowing in both the ribbon conductors and the return path wires creates its own magnetic field, which surrounds and penetrates the entire frame assembly and modulates the static magnetic field created by the magnets adhered to the ribbon frame. Modulation of the static magnetic field is undesirable because it distorts the static magnetic field which in turn leads to acoustic distortion of the sound created by the diaphragm in motion.

Additionally, the circuit created by the ribbon conductors and the return path wires forms physical loops, and electromagnetic interaction of these loops makes the ribbon transducer electrical circuit exhibit electrical self-inductive. Electrical self inductance is undesirable because it causes the transducer's electrical impedance to increase at high frequencies, creating electrical phase shift on the input electrical current and attenuating the acoustic output of the ribbon transducer at high frequencies.

### BRIEF DESCRIPTION OF THE INVENTION

In this invention, each return path wire is adhered to the frame assembly along most of its length with a layer of adhesive film such as adhesive tape, such that it is rigidly, attached to the frame assembly along most of its length and does not touch another return path wire along most of its length, the purpose of which is to eliminate mechanical vibration of each return path wire. This can be accomplished by adhering the return path wires widely spaced along the frame assembly, or by adhering the return path wires and adhesive film to the frame assembly in layers such that a layer of adhesive film separates each return path wire from the other return path wires along most of their length, or a combination of both.

As another aspect of this invention, the adhesive film applied to the return path wires as described above may contain an electrically conductive material (such as aluminum foil tape) or may be layered with electrically conductive material such that each individual return path wire is surrounded with electrically conductive material along most of its length. The electrically conductive layer acts to electromagnetically shield the return path wires from each other and from the diaphragm conductors. This reduces the ribbon transducer's electrical circuit self inductance and reduces electromagnetic modulation of the static magnetic field.

As another aspect of this invention, the faces of the magnets facing the edge of the ribbon diaphragm may be lined with an electrically conductive material which is electrically connected to one or more individual electromagnetic shield layers corresponding to one or more return path wires as described above. This electrically conductive material may cover other faces of the magnets as well. This further reduces the ribbon transducer's electrical circuit self inductance and further reduces electromagnetic modulation of the static magnetic field.

### DETAILED DESCRIPTION OF THE INVENTION

The invention was conceived of, designed and constructed as an electroacoustic transducer which displays improvement in dispersion and distortion.

This type of electroacoustic transducer is usually referred to as a “ribbon” transducer and is generally used for audio reproduction applications as a high frequency, mid-frequency or full range unit.

Many conventional ribbon transducer designs (FIGS. 1, 2, 3, 4, and 5) employ a diaphragm assembly (1.03, 2.03, 4.03, 5.03) made of several rows of conductive material (referred to as the “ribbon conductors”) (3.12) adhered to an electrically non-conductive film (3.11), forming a diaphragm assembly generally referred to as a “ribbon diaphragm assembly”. The diaphragm may or may not be corrugated, and may or may not be built into an arc. This ribbon diaphragm assembly is suspended between two parallel rows of magnets (1.02, 3.02, 4.02, 5.02) adhered to a steel frame (1.01, 2.01, 3.01, 4.01, 5.01). The frame is composed of two parallel steel section connected to each other near their ends with cross members (1.04, 2.04, 4.04). The steel frame may have additional elements such as additional steel, wood, or other materials attached, all of this together forming the frame assembly.

The magnets (1.02, 3.02, 4.02, 5.02) create a static magnetic field (1.06, 3.06, 4.06). This static magnetic field is not isolated within the frame. Stray magnetic field is also present surrounding and penetrating the entire frame

The ribbon conductors are generally electrically connected in series, with the end of one row electrically connected to the start of another row via a conductive wire. These wires are referred to as the “return path wires” (2.10, 3.10, 4.10). This leaves the start of at least one ribbon conductor and the end of at least one return path wire unconnected (4.11), and these are used as the beginning and end of the electric circuit defined by the ribbon conductors and return path wires.

The electrical circuit of the ribbon conductors, return path wires and other associated wiring is then connected to an electrical source such as an audio amplifier, which feeds current into the circuit. Interaction between alternating current flowing though the ribbon conductors and the static magnetic field causes the ribbon conductors and therefore the diaphragm to vibrate, producing sound

Because the electrical current carried within the return path wires is also immersed in magnetic field, the return path wires will also vibrate. Vibration of the return path wires within this magnetic field is undesirable because vibration induces an electromotive force on the electrons within the wires (called “back emf”) which then flow through the ribbon electrical circuit in the form of “back emf current”. The back emf current distorts the electrical signal from the amplifier, leading to acoustic distortion. In addition, the vibrating return path wires may create sound of their own or can buzz against each other and/or against the frame assembly. Past designs have partially solved this problem by bundling the return path wires or by adhering them at several points to the frame (4.12).

In this invention, referring to FIGS. 6 and 7, each return path wire (6.10, 7.10) is adhered to the frame assembly (6.01, 7.01) along most of its length with a layer of adhesive film such as adhesive tape (6.15, 7.15), such that it is rigidly attached to the frame assembly along most of its length and does not touch another return path wire along most of its length, the purpose of which is to eliminate mechanical vibration of each return path wire. This can be accomplished by adhering the return path wires widely spaced along the frame assembly, or by adhering the return path wires and adhesive film to the frame assembly in layers (7.15) such that a layer of adhesive film separates each return path wire from the other return path wires along most of their length, or a combination of both.

Additionally (referring to FIG. 5) the alternating current flowing in both the ribbon diaphragm assembly (5.03) creates its own magnetic field (5.14), and alternating current flowing in the return path wires (5.10) creates its own magnetic field (5.13), both of which surrounds and penetrates the entire frame assembly and modulates the static magnetic field created by the magnets (5.02) adhered to the ribbon frame (5.01). Modulation of the static magnetic field is undesirable because it creates distortion in the static magnetic field which in turn leads to acoustic distortion of the sound created by the ribbon diaphragm in motion.

Additionally, the circuit created by the ribbon conductors and the return path wires forms physical loops, and electromagnetic interaction of these loops makes the ribbon transducer electrical circuit exhibit electrical self-inductive. Electrical self inductance is undesirable because it causes the transducer's electrical impedance to increase at high frequencies, creating electrical phase shift on the input electrical current and attenuating the acoustic output of the ribbon transducer at high frequencies.

As another aspect of this invention (referring to FIGS. 8, 9, and 10), the adhesive film (8.16, 9.16, 10.16) applied to the return path wires (8.10, 9.10, 10.10) may contain an electrically conductive material or may be layered with electrically conductive material such that each individual return path wire is surrounded with electrically conductive material along most of its length. The electrically conductive layer acts to electromagnetically shield the return path wires from each other and from the diaphragm conductors. This reduces the ribbon transducer's electrical circuit self inductance and reduces electromagnetic modulation of the static magnetic field created by the magnets (8.02, 9.02, 10.02)

As another aspect of this invention (referring to FIGS. 9 and 10), the faces of the magnets (9.02, 10.02) facing the edge of the ribbon diaphragm may be lined with an electrically conductive material (9.18, 10.18) which is electrically connected (9.17, 10.17) to one or more individual electromagnetic shield layers (9.16, 10.16) corresponding to one or more return path wires (9.10, 10.10) as described above. This electrically conductive material may cover other faces of the magnets as well. This further reduces the ribbon transducer's electrical circuit self inductance and further reduces electromagnetic modulation of the static magnetic field.

### BRIEF DESCRIPTION OF THE DRAWINGS

FIG. 1) Conventional Ribbon Transducer (Front View)

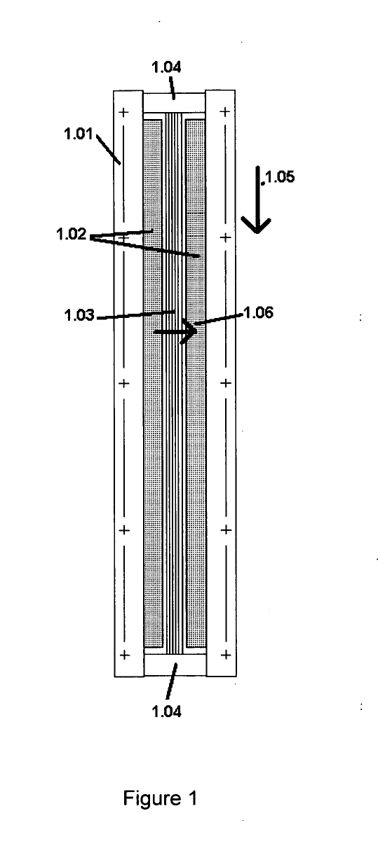

FIG. 2) Conventional Ribbon Transducer (Side Section View)

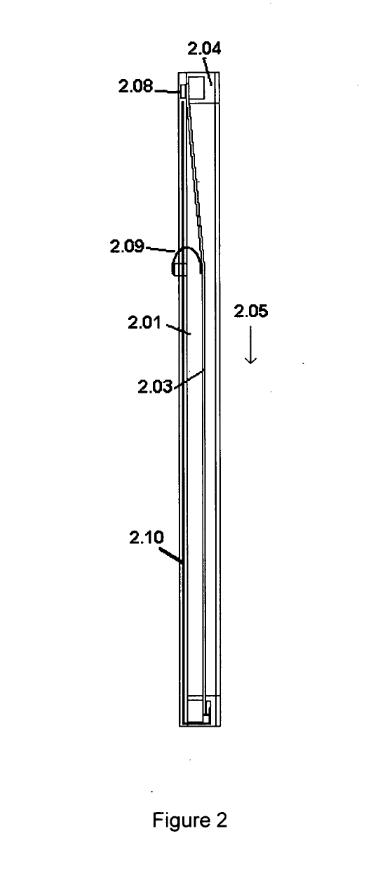

FIG. 3) Conventional Ribbon Transducer (Section View)

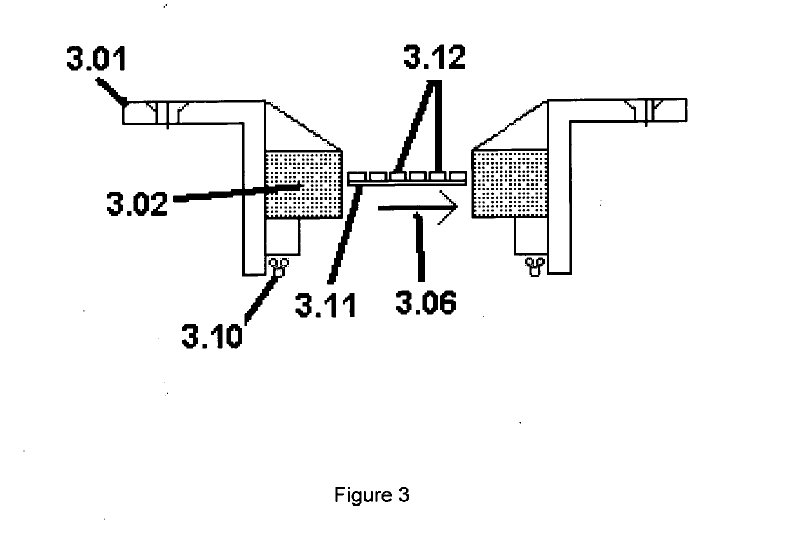

FIG. 4) Ribbon Diaphragm Assembly and Return Path Wires (Front View)

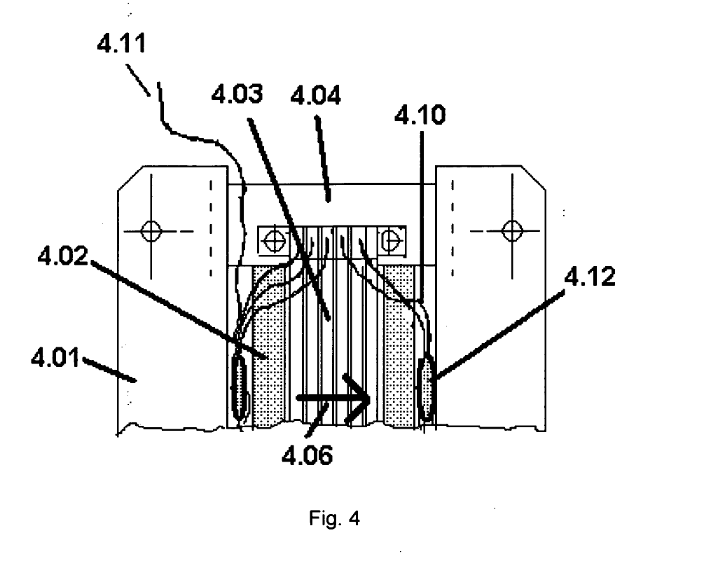

FIG. 5) Magnetic Fields created by electrical current flow (Section View).

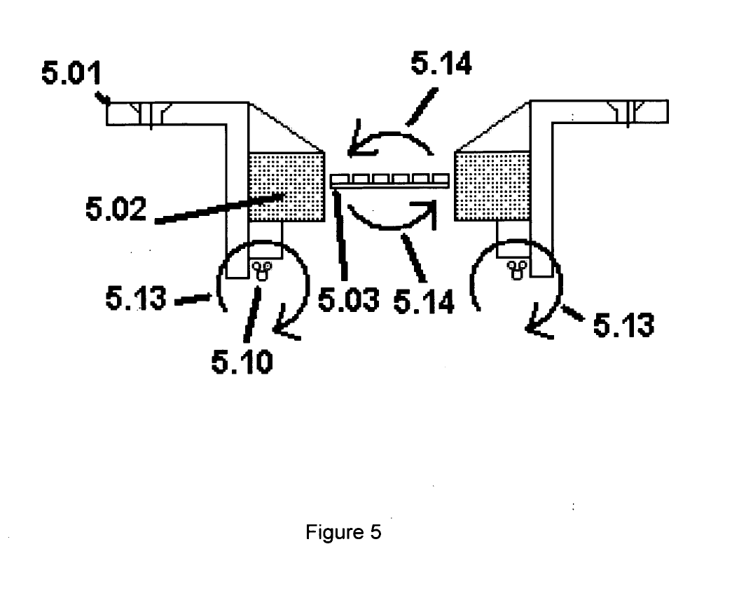

FIG. 6) Return Path Wires adhered to Ribbon Frame with Adhesive Film (Front View).

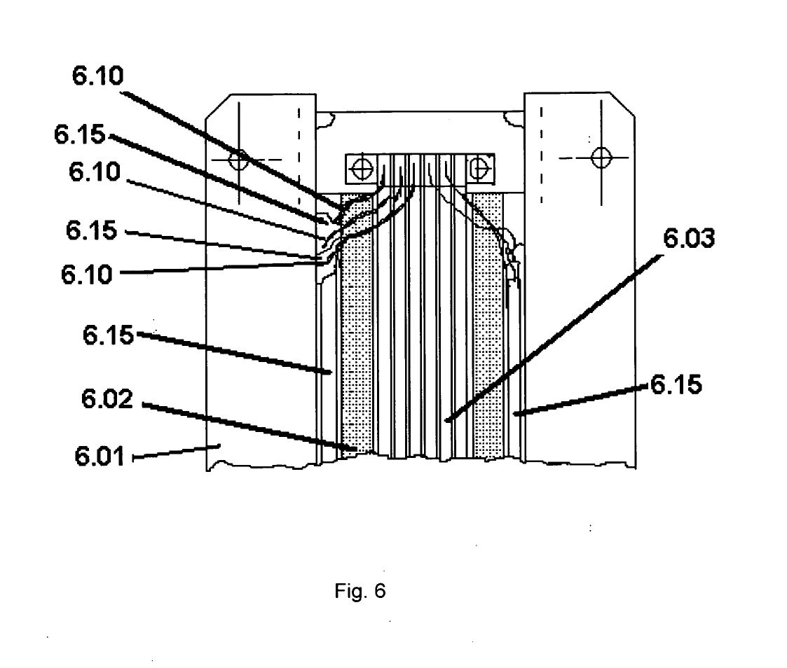

FIG. 7) Return Path Wires adhered to Ribbon Frame with Adhesive Film (Section View).

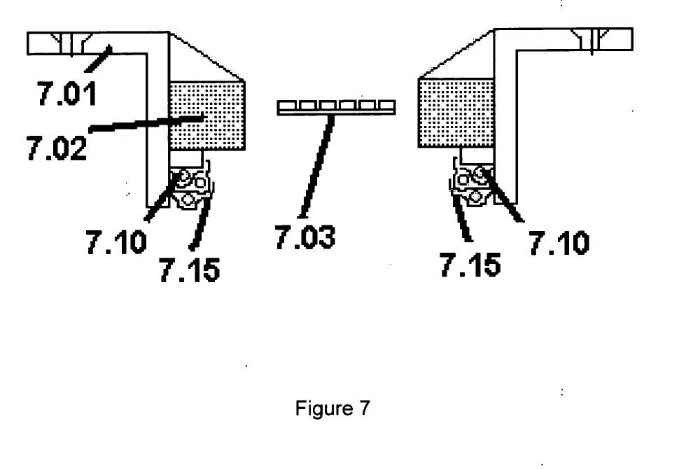

FIG. 8) Return Path Wires and Electromagnetic Shields (Front View).

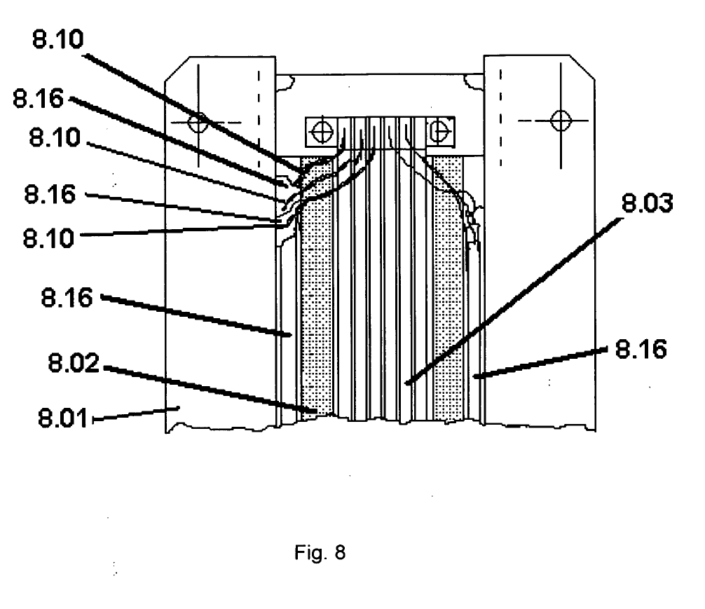

FIG. 9) Electrically Conductive Magnet Lining electrically connected to Return Path Wire Electromagnetic Shields (Front View)

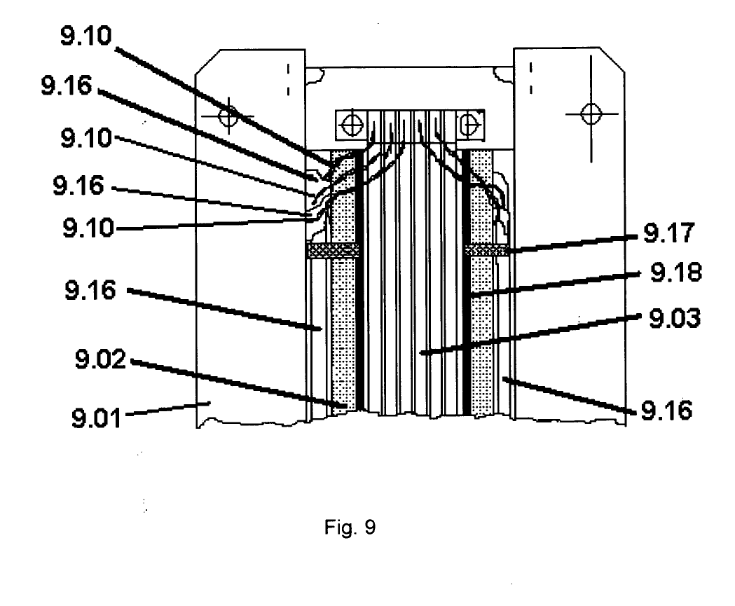

FIG. 10) Electrically Conductive Magnet Lining electrically connected to Return Path Wire Electromagnetic Shields (Section View)

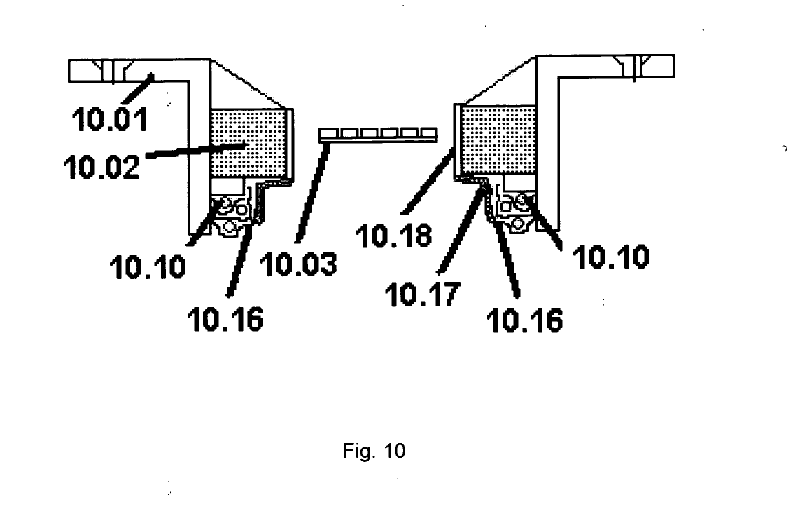

1) Each return path wire is adhered to the frame assembly along most of its length with a layer of adhesive film such as adhesive tape, such that it is rigidly attached to the frame assembly along most of its length and does not touch another return path wire along most of its length, the purpose of which is to eliminate mechanical vibration of each return path wire. This can be accomplished by adhering the return path wires widely spaced along the frame assembly, or by adhering the return path wires and adhesive film to the frame assembly in layers such that a layer of adhesive film separates each return path wire from the other return path wires along most of their length, or a combination of both. This eliminates mechanical vibration of the return path wires, preventing them from creating “back emf” current and preventing them from making sound of their own, lowering distortion.

2) The adhesive film in claim (1) above may contain an electrically conductive layer or be layered with electrically conductive material such that each return path wire is surrounded in electrically conductive materiel along most of its length, which forms and acts as an electromagnetic shield. This reduces the ribbon transducer's self inductance and reduces modulation of the transducer's static magnetic field, lowering distortion.

3) The face of the magnets facing the edge of the ribbon diaphragm may also be covered in electrically conductive material and this material is electrically connected to one or more of the return path wires' electromagnetic shields as described in claim (2) above. This electrically conductive material may cover other faces of the magnets as well. This further reduces the ribbon transducer's self inductance and further reduces modulation of the static magnetic field, lowering distortion.
